(19) United States
(12) Patent Application Publication
(10) Pub. No.: US 2025/0124343 A1
(43) Pub. Date: Apr. 17, 2025

(54) METHOD AND SYSTEM FOR DETERMINING FINAL RESULT USING FEDERATED LEARNING

(71) Applicant: Foundation for Research and Business, Seoul National University of Science and Technology, Seoul (KR)

(72) Inventors: Seung Eun LEE, Seoul (KR); Jeong Eun KIM, Gyeonggi-do (KR); Young Woo JEONG, Seoul (KR)

(73) Assignee: Foundation for Research and Business, Seoul National University of Science and Technology, Seoul (KR)

(21) Appl. No.: 18/529,700

(22) Filed: Dec. 5, 2023

(30) Foreign Application Priority Data
Oct. 13, 2023 (KR) 10-2023-0137195

(51) Int. Cl. G06N 20/00

(52) U.S. Cl. CPC G06N 20/00

(57) ABSTRACT

Provided is a method and system for determining a final result using federated learning. The method includes, based on performance of artificial intelligence (AI) models of each of federated learning devices, determining weights of each of the AI models, inputting input data to each of the AI models by each of the federated learning devices, and determining a final result for the input data by a final result determination server based on outputs and the weights of the AI models.

### CROSS-REFERENCE TO RELATED APPLICATIONS

This application claims the benefit of Korean Patent Application No. 10-2023-0137195 filed on Oct. 13, 2023, in the Korean Intellectual Property Office, the entire disclosure of which is incorporated herein by reference for all purposes.

### BACKGROUND

### 1. Field of the Invention

One or more embodiments relate to a method and system for determining a final result using federated learning, and more particularly, to a method and system for determining a final result when artificial intelligence (AI) modules of federated learning devices output different results.

### 2. Description of the Related Art

Federated learning is a learning method that trains a model by distributing pieces of learning data between artificial intelligence (AI) devices or devices. Federated learning may improve the quality and performance of a model while alleviating concerns about privacy and data security by updating of the model while preserving learning data on each of different local devices.

However, one of the main problems with a system that determines a final result using federated learning is that it is difficult to determine which result is the correct result when AI models learned through federated learning output different results.

Therefore, there is a need for a method of determining a correct final result even when AI models output different results.

### SUMMARY

Embodiments provide a method and system for preventing errors due to different outputs of federated learning devices and improving the accuracy of a final result by setting weights according to the performance of each of AI models and determining the final result using the weights when outputs of the federated learning devices are different from each other.

According to an aspect, there is provided a method of determining a final result using federated learning, the method including, based on performance of artificial intelligence (AI) models of each of federated learning devices, determining weights of each of the AI models, inputting input data to each of the AI models by each of the federated learning devices, and determining a final result for the input data by a final result determination server based on outputs and the weights of the AI models.

The determining of the final result may include determining whether the final result is determinable by a majority vote from the outputs of the AI models, determine outputs of which a number is a largest among different numbers of outputs with the same value as the final result when the final result is determinable by a majority vote, determining an output with a largest value obtained by applying the weights to each of the outputs of the AI models as the final result when the final result is not determinable by a majority vote.

The method may further include learning the AI models by inputting learning data to the AI models and determining the performance of the AI models by evaluating learned AI models.

According to another aspect, there is provided a system for determining a final result using federated learning, the system including, based on performance of AI models of each of federated learning devices, an AI model weight determination device configured to determine weights of each of the AI models, federated learning devices configured to input input data to each of the AI models, and a final result determination server configured to determine a final result for the input data based on outputs and the weights of the AI models.

The final result determination server may be configured to determine whether the final result is determinable by a majority vote from the outputs of the AI models, determine outputs of which a number is a largest among different numbers of outputs with the same value as the final result when the final result is determinable by a majority vote, and determine an output with a largest value obtained by applying the weights to each of the outputs of the AI models as the final result when the final result is not determinable by a majority vote.

Additional aspects of embodiments will be set forth in part in the description which follows and, in part, will be apparent from the description, or may be learned by practice of the disclosure.

According to embodiments, the present disclosure may set weights according to the performance of each of AI models and determine a final result using the weights when outputs of federated learning devices are different from each other, so errors due to different outputs of the federated learning devices may be prevented and the accuracy of the final result may be improved.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a final result determination system using federated learning according to an embodiment;

FIG. 2 is a diagram illustrating an example of an operation of a final result determination system using typical learning;

FIG. 3 is a diagram illustrating an example of an operation of a final result determination system using federated learning according to an embodiment;

FIG. 4 is a diagram illustrating an example of a final result of a final result determination method using federated learning according to an embodiment; and

FIG. 5 is a flowchart illustrating a final result determination method using federated learning according to an embodiment.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Hereinafter, embodiments will be described in detail with reference to the accompanying drawings.

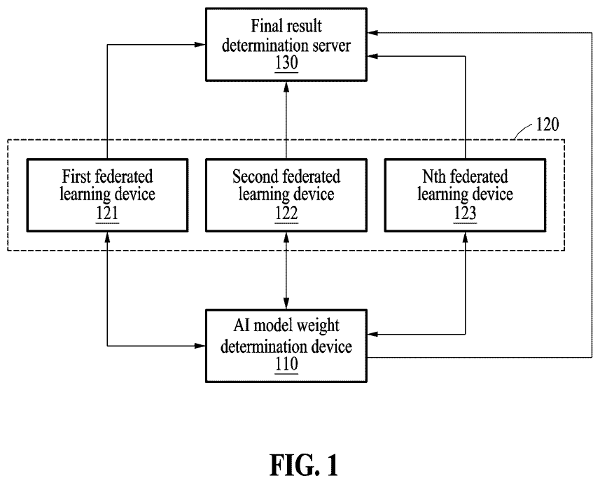

FIG. 1 is a diagram illustrating a final result determination system using federated learning according to an embodiment.

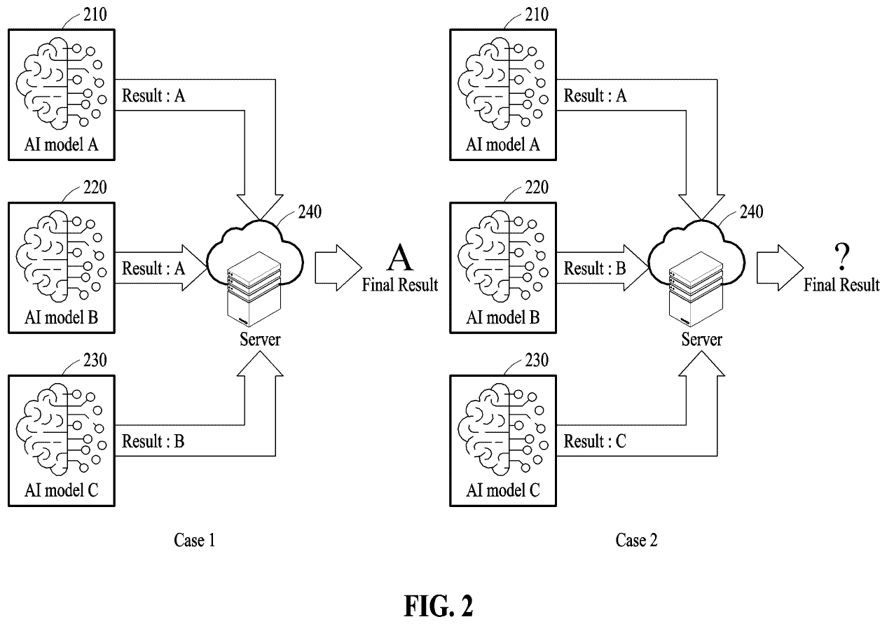

The final result determination system using federated learning according to an embodiment of the present disclosure may include an artificial intelligence (AI) model weight determination device 110, federated learning devices 120, and a final result determination server 130, as shown in FIG. 1. Here, the AI model weight determination device 110 and the federated learning devices 120 may be terminals or devices including different processors, as shown in FIG. 2. In addition, the AI model weight determination device 110, the federated learning devices 120, and the final result determination server 130 may be one server or different processors included in a terminal and may be each module included in a program performed by one processor.

In addition, the federated learning devices 120 may include a first federated learning device 121, a second federated learning device 122 to an Nth federated learning device 123, as shown in FIG. 1. Here, N may be the number of federated learning devices 120 included in the final result determination system using federated learning. For example, when the final result determination system using federated learning includes five federated learning devices 120, N may be 5 and the final result determination system using the federated learning may include the first federated learning device 121 to a fifth federated learning device.

The AI model weight determination device 110 may determine weights of each of AI models based on the performance of the AI models of each of the federated learning devices 120. Here, the AI model weight determination device 110 may determine the weights of each of the AI models to be proportional to the performance of the AI models of each of the federated learning devices 120.

The federated learning devices 120 may learn the AI models by inputting learning data to each of the AI models. Here, the AI model weight determination device 110 may determine the performance of the AI models by evaluating the learned AI models. For example, the AI model weight determination device 110 may determine the degree of consistency between outputs of the learned AI models and ground truth (GT) data included in the learning data and determine the determination result as the performance of the AI models. In addition, a separate processor or device may determine the performance of the AI models by evaluating the AI models and the AI model weight determination device 110 may receive the performance of the AI models from the processor or device.

Each of the first federated learning device 121, the second federated learning device 122 to the Nth federated learning device 123 may input the input data to each AI model of the first federated learning device 121, the second federated learning device 122 to the Nth federated learning device 123.

The final result determination server 130 may determine a final result based on the outputs of the AI models of the federated learning devices 120 and the weights of each of the AI models determined by the AI model weight determination device 110.

Specifically, the final result determination server 130 may determine whether the final result is determinable by the majority vote from the outputs of the AI models. Specifically, the final result determination server 130 may search for outputs with the same value among the outputs of the AI models. When all values of the outputs of the AI models are different from each other, the final result determination server 130 may determine that the final result is not determinable by the majority vote.

When the values of the outputs of the AI models are the same, the final result determination server 130 may determine whether the number of outputs with the same value is the same as a different number of outputs with the same value. When the number of outputs with the same value is the same as a different number of outputs with the same value, the final result determination server 130 may determine that the final result is not determinable by the majority vote. When the number of outputs with the same value is not the same as a different number of outputs with the same value, the final result determination server 130 may determine that the final result is determinable by the majority vote.

When the final result is determinable by the majority vote, the final result determination server 130 may determine outputs of which the number is the largest among different numbers of outputs with the same value as the final result.

When the final result is not determinable by the majority vote, the final result determination server 130 may determine an output with the largest value obtained by applying the weights to each of the outputs of the AI models as the final result.

The final result determination system using federated learning according to an embodiment of the present disclosure may set the weights according to the performance of each of the AI models and determine the final result using the weights when the outputs of the federated learning devices 120 are different from each other, so errors due to the different outputs of the federated learning devices 120 may be prevented and the accuracy of the final result may be improved.

FIG. 2 is a diagram illustrating an example of an operation of a final result determination system using typical learning.

In the final result determination system using learning according to the related art, as shown in case 1, when an AI model A of a first federated learning device 210 and an AI model B of a second federated learning device 220 output a result A and an AI model C of a third federated learning device 230 outputs a result B, a server 240 may output A as a final result according to the majority vote.

However, as shown in case 2, when the AI model A of the first federated learning device 210, the AI model B of the second federated learning device 220, and the AI model C of the third federated learning device 230 output different results A, B, and C, there may be a possibility that the server 240 makes an error that may not determine the final result or determines a result that is not appropriate for the input data as the final result by selecting one of A, B, and C randomly.

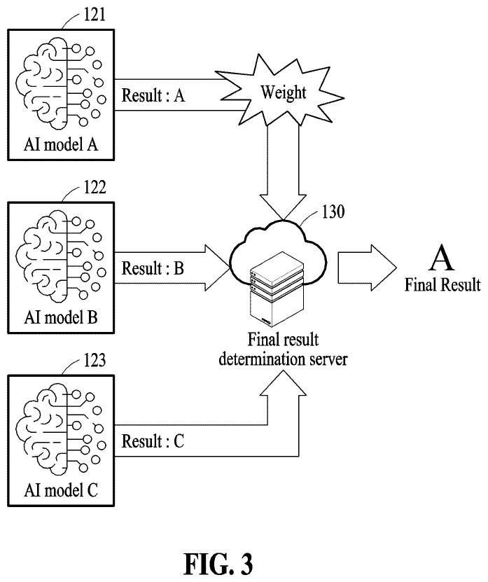

FIG. 3 is a diagram illustrating an example of an operation of a final result determination system using federated learning according to an embodiment.

In the final result determination system using federated learning according to an embodiment of the present disclosure, when an AI model A of the first federated learning device 121, an AI model B of the second federated learning device 122, and an AI model C of the Nth federated learning device 123 output different results A, B, and C, the final result determination server 130 may apply a weight of the AI model A, a weight of the AI model B, and a weight of the AI model C to the results A, B, and C, respectively. In addition, when the value obtained by applying the weight of the AI model A to the result A is greater than the value obtained by applying the weight of the AI model B to the result B and the value obtained by applying the weight of the AI model C to the result C, the final result determination server 130 may determine the result A as the final result.

The higher the performance of the AI model, the higher the accuracy of the result, and the lower the performance of the AI model, the lower the accuracy of the result. That is, the result output from an AI model with low performance may more likely be an incorrect result than the result output from an AI model with high performance.

Accordingly, in the final result determination method using federated learning, when the AI models of the federated learning devices output different results, the final result determination server 130 may improve the accuracy of the final result by determining the final result by prioritizing a result output from an AI model with the highest performance.

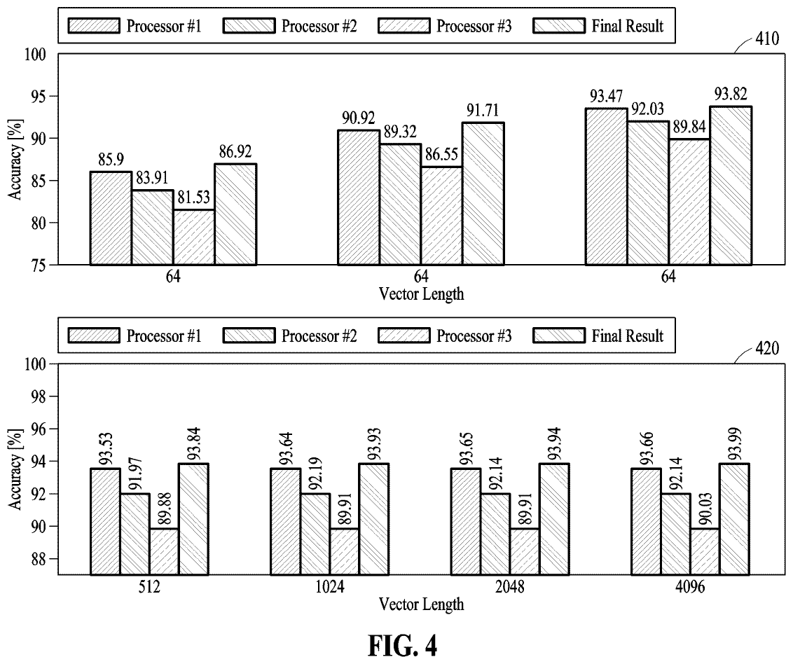

FIG. 4 is a diagram illustrating an example of a final result of a final result determination method using federated learning according to an embodiment.

A graph 410 and a graph 420 in FIG. 4 show the change in accuracy according to the change of a vector length for the result output from each of the AI models of the federated learning devices for the different pieces of input data and the final result determined by the final result determination server 130. In FIG. 4, Processor #1 may be an output of an AI model with the highest performance among the AI models of the federated learning devices, Processor #2 may be an output of an AI model with the second highest performance among the AI models of the federated learning devices, and Processor #3 may be an output of an AI model with the lowest performance among the AI models of the federated learning devices.

As shown in FIG. 4, the final result determined by the final result determination server 130 may have higher accuracy than the output of the AI model with the highest performance among the AI models of the federated learning devices.

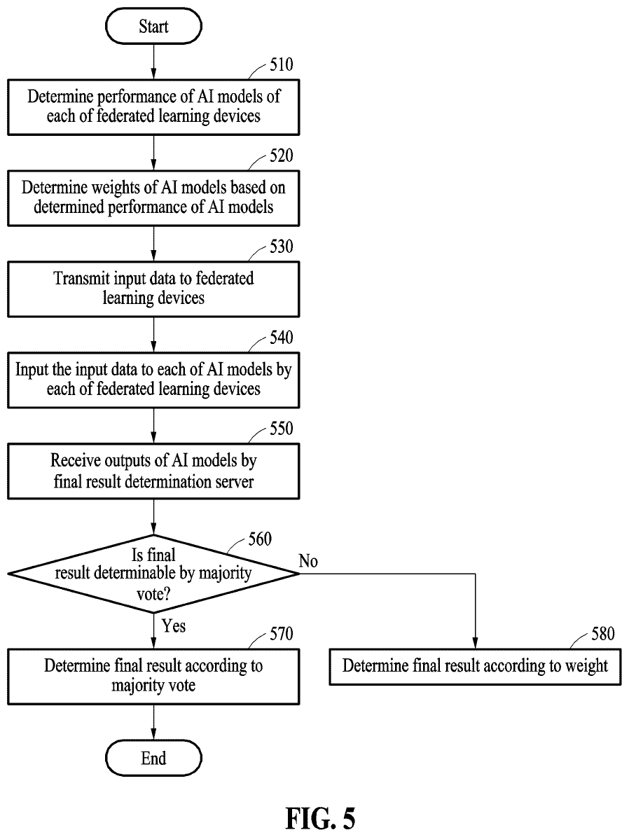

FIG. 5 is a flowchart illustrating a final result determination method using federated learning according to an embodiment.

In operation 510, the federated learning devices 120 may learn AI models by inputting learning data to each of the AI models. Here, the AI model weight determination device 110 may determine the performance of the AI models by evaluating the learned AI models. For example, the AI model weight determination device 110 may determine the degree of consistency between outputs of the learned AI models and GT data included in the learning data and determine the determination result as the performance of the AI models.

In operation 520, the AI model weight determination device 110 may determine weights of each of the AI models based on the performance of the AI models of each of the federated learning devices 120 determined in operation 510. Here, the AI model weight determination device 110 may determine the weights of each of the AI models to be proportional to the performance of the AI models of each of the federated learning devices 120.

In operation 530, an external input interface or the AI model weight determination device 110 may transmit input data to each of the first federated learning device 121, the second federated learning device 122 to the Nth federated learning device 123.

In operation 540, each of the first federated learning device 121, the second federated learning device 122 to the Nth federated learning device 123 may input the input data received from operation 530 to each of the AI models of the first federated learning device 121, the second federated learning device 122 to the Nth federated learning device 123.

In operation 550, each of the first federated learning device 121, the second federated learning device 122 to the Nth federated learning device 123 may transmit results output from each of the AI models to the final result determination server 130.

In operation 560, the final result determination server 130 may determine whether the final result is determinable by the majority vote from outputs of the AI models. Specifically, the final result determination server 130 may search for outputs with the same value among the outputs of the AI models. When all values of the outputs of the AI models are different from each other, the final result determination server 130 may determine that the final result is not determinable by the majority vote.

When the values of the outputs of the AI models are the same, the final result determination server 130 may determine whether the number of outputs with the same value is the same as a different number of outputs with the same value. When the number of outputs with the same value is the same as a different number of outputs with the same value, the final result determination server 130 may determine that the final result is not determinable by the majority vote. When the number of outputs with the same value is not the same as a different number of outputs with the same value, the final result determination server 130 may determine that the final result is determinable by the majority vote.

When the final result is determinable by the majority vote, the final result determination server 130 may perform operation 570. When the final result is not determinable by the majority vote, the final result determination server 130 may perform operation 580.

In operation 570, the final result determination server 130 may determine outputs of which the number is the largest among different numbers of outputs with the same value as the final result.

In operation 580, the final result determination server 130 may determine an output with the largest value obtained by applying the weights to each of the outputs of the AI models as the final result.

The present disclosure may set the weights according to the performance of each of the AI models and determine the final result using the weights when the outputs of the federated learning devices 120 are different from each other, so errors due to the different outputs of the federated learning devices 120 may be prevented and the accuracy of the final result may be improved.

Furthermore, the federated learning devices or the final result determination method using federated learning based on speech data according to the present disclosure is provided as a computer-executable program and may be implemented as various recording media such as magnetic storage media, optical reading media, digital storage media, etc.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned embodiments is required for all the embodiments, and it should be understood that the aforementioned program components and apparatuses may be integrated into a single software product or packaged into multiple software products.

The embodiments disclosed in the present specification and the drawings are intended merely to present specific examples in order to aid in understanding of the disclosure, but are not intended to limit the scope of the disclosure. It will be apparent to those skilled in the art that various modifications based on the technical spirit of the disclosure, as well as the disclosed embodiments, can be made.

What is claimed is:

1. A method of determining a final result using federated learning, the method comprising:
based on performance of artificial intelligence (AI) models of each of federated learning devices, determining weights of each of the AI models;
inputting input data to each of the AI models by each of the federated learning devices; and
determining a final result for the input data by a final result determination server based on outputs and the weights of the AI models.

2. The method of claim 1, wherein the determining of the final result comprises:
determining whether the final result is determinable by a majority vote from the outputs of the AI models;
determine outputs of which a number is a largest among different numbers of outputs with the same value as the final result when the final result is determinable by a majority vote; and
determining an output with a largest value obtained by applying the weights to each of the outputs of the AI models as the final result when the final result is not determinable by the majority vote.

3. The method of claim 1, further comprising:
learning the AI models by inputting learning data to the AI models; and
determining the performance of the AI models by evaluating the learned AI models.

4. A system for determining a final result using federated learning, the system comprising:
based on performance of artificial intelligence (AI) models of each of federated learning devices, an AI model weight determination device configured to determine weights of each of the AI models;
federated learning devices configured to input input data to each of the AI models; and
a final result determination server configured to determine a final result for the input data based on outputs and the weights of the AI models.

5. The system of claim 4, wherein the final result determination server is configured to determine whether the final result is determinable by a majority vote from the outputs of the AI models, determine outputs of which a number is a largest among different numbers of outputs with the same value as the final result when the final result is determinable by a majority vote, and determine an output with a largest value obtained by applying the weights to each of the outputs of the AI models as the final result when the final result is not determinable by a majority vote.
